(19) United States
(12) Patent Application Publication
(10) Pub. No.: US 2013/0273435 A1
(43) Pub. Date: Oct. 17, 2013

(54) LAYER SYSTEM FOR ELECTROCHEMICAL CELLS

(71) Applicant: BASF SE, Ludwigshafen (DE)

(72) Inventors: Klaus LEITNER, Ludwigshafen (DE); Alexander Panchenko, Ludwigshafen (DE); Oliver Gronwald, Frankfurt (DE); Ruediger Oesten, Frankenthal (DE); Evgueni Klimov, Ludwigshafen (DE)

(73) Assignee: BASF SE, Ludwigshafen (DE)

(21) Appl. No.: 13/859,948

(22) Filed: Apr. 10, 2013

Related U.S. Application Data
(60) Provisional application No. 61/623,606, filed on Apr. 13, 2012.

(51) Int. Cl. H01M 4/60; H01M 4/04

(52) U.S. Cl. CPC H01M 4/602; H01M 4/0402
USPC 429/309; 429/188; 427/462

(57) ABSTRACT

A layer system for electrochemical cells comprising at least one fibrous nonwoven fabric (A) formed by fibers of one or more organic polymers or mixtures of organic polymers (A1) wherein
(i) the fibrous nonwoven fabric (A) contains a polymer electrolyte (C) comprising
   (C1) an electrolyte solvent or a mixture of electrolyte solvents,
   (C2) at least one electrolyte salt, and
   (C3) at least one organic polymer or polymer mixture,
and/or
(ii) a second fibrous nonwoven fabric (B) formed by fibers of one or more organic polymers or mixtures of organic polymers (B1) is aligned parallel to (A), wherein (B) may contain a polymer electrolyte (D) comprising
   (D1) an electrolyte solvent or a mixture of electrolyte solvents,
   (D2) at least one electrolyte salt, and
   (D3) at least one organic polymer or polymer mixture.

The present invention relates to a layer system for electrochemical cells comprising at least one fibrous nonwoven fabric (A) formed by fibers of one or more organic polymers or mixtures of organic polymers (A1) wherein
(i) the fibrous nonwoven fabric (A) contains a polymer electrolyte (C) comprising
   (C1) an electrolyte solvent or a mixture of electrolyte solvents,
   (C2) at least one electrolyte salt, and
   (C3) at least one organic polymer or polymer mixture,

and/or
(ii) a second fibrous nonwoven fabric (B) formed by fibers of one or more organic polymers or mixtures of organic polymers (B1) is aligned parallel to (A), wherein (B) may contain a polymer electrolyte (D) comprising
   (D1) an electrolyte solvent or a mixture of electrolyte solvents,
   (D2) at least one electrolyte salt, and
   (D3) at least one organic polymer or polymer mixture.

The present invention further relates to the electrodes and electrochemical cells comprising the inventive layer systems, and to the production of the inventive layer systems.

Secondary batteries or rechargeable batteries are just some embodiments by which electrical energy can be stored after generation and used when required. Owing to the significantly better power density, lithium batteries have attracted great attention. Lithium batteries include different types of batteries wherein lithium ion batteries are the most important at present. In lithium ion batteries the charge transport in the electrical cell is accomplished by lithium ions. In many cases, lithium-containing mixed transition metal oxides are used as cathode active materials in lithium ion batteries, especially lithium-containing nickel-cobalt-manganese oxides with layer structure, or manganese-containing spinels which may be doped with one or more transition metals. However, a problem with many batteries remains that of cycling stability, which is still in need of improvement. Specifically in the case of those batteries which comprise a comparatively high proportion of manganese, for example in the case of electrochemical cells with a manganese-containing spinel electrode and a graphite anode, a severe loss of capacity is frequently observed within a relatively short time. In addition, it is possible to detect deposition of elemental manganese on the anode in cases where graphite anodes are selected as counter electrodes. It is believed that these manganese nuclei deposited on the anode, at a potential of less than 1V vs. Li/Li+, act as a catalyst for a reductive decomposition of the electrolyte. This is also thought to involve irreversible binding of lithium, as a result of which the lithium ion battery gradually loses capacity. Other transition metals contained in the cathode active material may be dissolved in the electrolyte during cycling the electrochemical cell analogously. These transition metals migrate towards the anode and are reduced and deposited on the anode due to the low potential. Even small amounts of such metal impurities may change the interface between electrolyte and anode and may lead to a reduced life time of the battery. In lithium ion batteries liquid electrolytes are widely used. Liquid electrolytes may cause problems due to possible leakage of the liquid electrolytes. An alternative to overcome this disadvantage is the use of polymer gel electrolytes. However, known polymer gel electrolytes can often not completely satisfy the requirements for the high mechanical strength, long-term phase stability and good adhesion to the electrode.

New horizons with regard to energy density have been opened up by lithium-sulfur cells. In lithium-sulfur cells, sulfur in the cathode is reduced via polysulfide ions to S²⁻, which is reoxidized to form sulfur-sulfur bonds when the cell is charged. A problem, however, is the solubility of the polysulfides, for example Li₂S₄ and Li₂S₆, which are soluble in the solvent and can migrate to the anode. The consequences may include: loss of capacitance and deposition of electrically insulating material on the sulfur particles of the electrode. The migration from cathode to anode can ultimately lead to discharge of the affected cell and to cell death in the battery as described in Solid State Ionics 2004, 175, 243-245. This unwanted migration of polysulfide ions is also referred to as “shuttling”, a term which is also used in the context of the present invention.

It was thus an object of the present invention to provide a material which is simple to produce and which avoids the disadvantages known from the prior art. The material should be mechanically stable, providing high lithium ion conductivity and confer improved cycling stability to the lithium-sulfur cell. It was a further object of the present invention to provide a process by which a corresponding protective material can be produced.

This object is achieved by a layer system for electrodes of electrochemical cells comprising at least one fibrous nonwoven fabric (A) formed by fibers of one or more organic polymers or mixtures of organic polymers (A1) wherein
(i) the fibrous nonwoven fabric (A) contains a polymer electrolyte (C) comprising
   (C1) an electrolyte solvent or a mixture of electrolyte solvents,
   (C2) at least one electrolyte salt, and
   (C3) at least one organic polymer or polymer mixture,

and/or
(ii) a second fibrous nonwoven fabric (B) formed by fibers of one or more organic polymers or mixtures of organic polymers (B1) is aligned parallel to (A), wherein (B) may contain a polymer electrolyte (D) comprising
   (D1) an electrolyte solvent or a mixture of electrolyte solvents,
   (D2) at least one electrolyte salt, and
   (D3) at least one organic polymer or polymer mixture.

The inventive layer system may be used as electrolyte with high mechanical strength and good adhesion to the electrode, as separator or as protective layer for the electrodes in an electrochemical cell, especially in a lithium battery. For example, the layer system may be used as protective layer for an anode comprising metallic lithium, a lithium alloy or a lithium ion intercalating compound as anode active material or as protective layer for a cathode comprising a lithium ion intercalating compound or sulphur as cathode active material. In a lithium sulphur battery the inventive layer system may reduce the contact of polysulfides solved to the anode and therefore leading to a longer lifetime and/or cycle stability of the battery.

The term “anode” denotes the negative electrode; the term “cathode” denotes the positive electrode of the lithium battery.

In the context of the present invention the term “lithium battery” refers to secondary (rechargeable) electrochemical cells comprising electrochemical active material containing lithium or lithium ions in the cathode or the anode, e.g. lithium metal, lithium alloy and lithium intercalating compounds. Examples of lithium batteries include lithium ion batteries and lithium sulphur batteries.

The term “lithium ion battery” means a rechargeable electrochemical cell wherein during discharge lithium ions move from the negative electrode (anode) to the positive electrode (cathode) and during charge the lithium ions move from the positive electrode to the negative electrode, i.e. the charge transfer is performed by lithium ions. Usually lithium ion batteries comprise a cathode containing as cathode active material a lithium ion-containing transition metal compound, for example transition metal oxide compounds with layer structure like LiCoO₂, LiNiO₂, and LiMnO₂, or transition metal phosphates having olivine structure like LiFePO₄ and LiMnPO₄ or lithium-manganese spinels which are known to the person skilled in the art in lithium ion battery technology. The anode of a lithium ion battery contains as anode active material a lithium ion intercalating carbon compound, for example carbon black, so called hard carbon, which means carbon similar to graphite having larger amorphous regions than present in graphite, and graphite.

“Lithium sulphur battery” means a rechargeable electrochemical cell having an anode comprising as anode active material lithium metal or a lithium alloy and a cathode comprising as cathode active material sulphur, e.g. elemental sulphur. During discharge lithium is oxidized to lithium ions at the anode and sulphur is reduced in several steps to S²⁻.

The term “cathode active material” denotes the electrochemically active material in the cathode, e.g. the transition metal oxide intercalating/deintercalating the lithium ions during charge/discharge of a lithium ion battery. Depending on the state of the battery, i.e. charged or discharged, the cathode active material contains more or less lithium ions. In case of lithium sulphur batteries the cathode active material contains sulphur.

The term “anode active material” denotes the electrochemically active material in the anode. The anode active material in a lithium ion battery is usually a lithium ion intercalating compound having a lower electrochemical potential than the lithium ion intercalating compound used as cathode active material. Commonly used anode active materials for lithium ion batteries are for instance carbons in an electric conductive modification like graphite. In lithium sulphur batteries the anode active material is usually metallic lithium or a lithium alloy.

The inventive layer system comprises at least one fibrous nonwoven fabric (A). The term “fibrous nonwoven fabric” is used interchangeably with the term “nonwoven fabric” herein. Nonwoven fabrics are known to the person skilled in the art. They are formed directly from individual fibers which are bonded together as a result of inherent fiber-to-fiber friction (entanglement), mechanical treatment, heat, or chemical methods without a yarn being first made. The nonwoven fabric is essentially two dimensional, i.e. one dimension is very short whereas the other two dimensions are virtually unlimited compared to the third dimension, for instance like a sheet of paper.

According to the invention the fibrous nonwoven fabric (A) is formed by fibers of one or more organic polymers or mixtures of polymers (A1). The fibers forming the fibrous nonwoven fabric (A) usually have a diameter of from 10 to 3000 nm, preferably of from 50 to 2000 nm and most preferred of from 100 to 1000 nm. Such fine fibers will result in a very thin layer of the nonwoven fabric. The length of the fibers is usually at least two times of the diameter, preferred a multiple of the diameter, generally the length of the fibers is at least 5000 nm. Long fibers may form entanglements increasing the mechanical strength of the nonwoven fabric.

The fibrous nonwoven fabric (A) used according to the present invention has usually a porosity of at least 30%, preferred of from 40 to 70% and most preferred of from 50 to 60%, determined according to ASTM D-2873.

Usually the polymers or mixtures of polymers (A1) are selected with regard to the intended use of the layer system, in particular with regard to the electrolyte used in the electrochemical cell for which the layer system is produced. The organic polymer(s) or mixture(s) of polymers (A1) are selected from polymers which are not soluble in the electrolyte solvent/mixture of solvent used. In the context of the present invention “not soluble” means, that the polymer shows a maximum degree of swelling up to 100%, preferably up to 95%, more preferred up to 90% and most preferred up to 80%, based on the mass. Whether a polymer is not soluble according to the present invention may be determined by weighing a dry sample of the polymer in form of a flat film of about 1 cm×1cm×0.1 cm, immersing the sample in an excess of the respective electrolyte solvent/mixture of solvents for 24 h at 25° C., removing excess electrolyte and weighing the sample again. The degree of swelling (d_{S}) is calculated from the weight of the sample measured after immersing the sample in the electrolyte solvent/mixture of solvents (wₛ) and the weight of the dry sample (w_{d}) according to d_{S}=((wₛ/w_{d})−1)*100%.

The one or more organic polymers or mixtures of polymers (A1) may be selected from the group consisting of homo- and copolymers of aromatic vinylic monomers, homo- and copolymers of alkyl(meth)acrylates, homo- and copolymers of α-olefines, homo- and copolymers of aliphatic dienes, homo- and copolymers of vinyl halides, homo- and copolymers of vinyl acetate and their hydrolyzates, homo- and copolymers of acrylonitrile, homo- and copolymers of sulfones, homo- and copolymers of benzimidazole, homo- and copolymers of siloxanes, amino formaldehyde resins, homo- and copolyamides, homo- and copolyurethanes, homo- and copolyesters, homo- and copolyethers, homo- and copolyvinylpyrrolidone, and homo- and copolyvinylimidazol, polymeric ionic liquids, ionomers, copolymers formed by two or more of the aforesaid polymer forming monomers and monomer units, and mixtures of the aforementioned homo- and copolymers.

Ionomers are copolymers comprising large proportions of hydrophobic monomers and small proportions of comonomers carrying ionic groups, usually neutralized acid groups. Usually the amount of comonomers in the ionomer carrying ionic groups is below 15 mol-%, based on the whole ionmer, in particular the total amount of comonomers carrying partially or totally neutralized acid groups is below 15 mol-%.

An example of homo- and copolymers of aromatic vinylic monomers is polystyrene, examples of homo- and copolymers of alkyl(meth)acrylates are methyl(meth)acrylate and butyl(meth)acrylate, examples of homo- and copolymers of α-olefines are polyethylene and polypropylene, an example of homo- and copolymers of aliphatic dienes is polybutadiene, examples of homo- and copolymers of vinyl halides are polyvinylidene fluoride and polytetrafluoro ethylene, examples of homo- and copolymers of vinyl acetate and their hydrolyzates are polyvinylacetate and polyvinylalcohol, an example of homo- and copolymers of acrylonitrile is polyacrylnitril, examples of homo- and copolymers of sulfones are polysulfone and polyphenylene sulfone, an example of homo- and copolymers of benzimidazole ispolybenzimidazole, an example of homo- and copolymers of siloxanes is polysiloxane, an example of amino formaldehyde resins is melamine formaldehyde resin, examples of homo- and copolyamides are polyamide 6 and polyamide 6,6, examples of homo- and copolyesters are polyethylene terephthalate and polybutylene terephthalate, examples of homo- and copolyethers are polyethyleneoxide, polypropyleneoxide and polytetrahydrofurane, an example of homo- and copolyvinylpyrrolidone is polyvinylpyrrolidone, an example of homo- and copolyvinylimidazol is polyvinylimidazol, examples for ionomers are sulfonated fluorine-containing polymers like sulfonated poly(tetrafluoro ethylene), commercially available under the trademark NAFION® by DuPont, polymerised ionic liquids, sulfonated polyether ether ketones, sulfonated polyarylene ether sulfone, sulfonated co-polyimide and sulfonated polystyrene, and examples of copolymers formed by two or more of the aforesaid polymer forming monomers and monomer units are poly(stryrene butadiene) and poly(acrylonitrile butadiene styrene).

Preferably the one or more organic polymers or mixtures of polymers are selected from the group consisting of polvinylalcohol, polyvinylidene fluoride, polytetrafluoro ethylene, polyethylene terephthalate, polybutylene terephthalate, polysulfone, polyphenylene sulfone, melamine formaldehyde resin, polyacrylonitrile, polybenzimidazole, polypropyleneoxide, polytetrahydrofurane, polyethylene oxide, and mixtures thereof.

The fiber forming organic polymer(s) or mixtures of polymers (A1) may be cross-linked. If a polymer mixture (A1) is used for forming the fibers, the polymers contained in that mixture may be miscible or immiscible.

The fibers forming the nonwoven fibrous fabric (A) may contain at least one additive (E). The additive (E) may be selected from usual polymer additives like fire retardants, cross-linking agents, organic and inorganic fillers, and plasticizers, and particular additives like scavengers for transition metals etc.

According to one embodiment of the present invention the fibrous nonwoven fabric (A) is formed by fibers of one polymer or polymer mixture (A1), i.e. the nonwoven fabric is formed by fibers of the same type having same chemical characteristics.

According to another embodiment the fibrous nonwoven fabric (A) is formed by fibers of two or more different polymers or polymer mixtures (A1). In that case, the nonwoven fabric (A) is formed by fibers of different polymers or polymer mixtures (A1), i.e. by different types of fibers. The different types of fibers may be homogenously distributed within the nonwoven fabric, i.e. the nonwoven fabric is formed by a mixture of different types of fibers. However, the different types of fibers may form two or more layers as well. For example, the fibrous nonwoven fabric comprises a first layer formed by fibers of a first polymer or polymer mixture (A1) and a second layer formed by a second polymer or polymer mixture (A1) differing from the first polymer or polymer mixture (A1) resulting in a nonwoven fabric having two different surfaces formed by two different kinds of fibers with different chemical properties. A layer system having two different surfaces each formed by fibers of different polymers/polymer mixtures (A1) and/or by mixtures of fibers of different polymers/polymer mixtures (A1) may be advantageous since the different polymers/polymer mixtures/mixtures of fibers may be selected to fit different purposes. For instance, if the inventive layer system is placed in an electrochemical cell between the anode and the cathode each surface of the nonwoven fabric may be adopted to certain requirements of the anode and the cathode, respectively. Differing layers may be formed by different mixtures of fibers, too. In one embodiment the fibrous nonwoven fabric (A) is formed by two, three or four layers of fibers of different organic polymers or polymer mixtures (A1) and/or different mixtures of fibers of different organic polymers or polymer mixtures (A1). Each layer of fibers may be formed by a different type of fibers or a different mixture of fibers, or at least layers succeeding each other directly may be formed by different types of fibers or different mixtures of fibers. Preference is given to fibrous nonwoven fabrics (A) formed by two, three or four layers of different types of organic polymers or polymer mixtures (A1) and/or different mixtures of different types of organic polymers or polymer mixtures wherein the both outside layers building the surfaces of the fibrous nonwoven fabric are formed by different organic polymers or polymer mixtures (A1) and/or different mixtures of fibers formed by different organic polymers or polymer mixtures (A1), in particular preferred the fibrous nonwoven fabric (A) is formed by two layers of different organic polymers or polymer mixtures (A1) and/or formed by different mixtures of different organic polymers or polymer mixtures (A1).

The preparation of fine polymer fibers and nonwoven fabrics formed by these fibers are known to the person skilled in the art. Common spin processes are for example melt spinning, rotor spinning and electrospinning.

Preference is given to spunbonded nonwoven fabrics according to the present invention. Spunbonded nonwoven fabrics are spun directly from thermoplasts and are directly arranged into the web forming the nonwoven. Most spunbonded processes yield a sheet having planar-isotropic properties owing to the random laydown of the fibers. Unlike woven fabrics, spunbonded sheets are generally nondirectional and can be cut and used without concern for higher stretching in the bias direction or unraveling at the edges.

Especially preferred the fibers are manufactured by electrospinning or rotor spinning, in particular by electrospinning. By these methods it is possible to yield very thin fibers allowing the manufacture of very thin nonwoven fabrics directly in one process step. A further advantage is the possibility of using an electrode suited for an intended use as substrate for depositing the fibers in form of the nonwoven fabric. For example a lithium anode, a sulphur cathode, a transition metal oxide containing cathode or a graphite anode may be used as substrate and the nonwoven fabric may be deposited directly on the surface of the respective electrode during the spinning process.

A description of electrospinning can be found in D. H. Reneker and H. D. Chun, Nanotechn. 7 (1996), pages 216 f, A. Greiner and J. Wendorff, Angewandte Chemie Int. edition 119 (2007), pages 5770 to 5805 and S. Cavaliere and J. Roziere, Energy Environ. Sci. (2011), 4, pages 4761-4785. A further method for producing nanofibers and nonwovens by electrospinning is disclosed in WO 2009/010443 A2. Electrospinning of an organic polymer may be performed by any process known to the person skilled in the art, e.g. it is possible to use polymer melts, polymer solutions and polymer dispersions in the electrospinning process. The substrate is arranged in the electrical field of the elecrospinning device or as counter electrode in the electrospinning device, and the polymer melt, polymer solution or polymer dispersion is electrospun onto the substrate. If an electrode intended for use in an electrochemical cell is used as substrate the nonwoven fibrous fabric (A) may be directly deposited on the electrode. It is possible to use more than one spinning nozzle and to spin two different polymer melts, polymer solutions or polymer dispersions at once or consecutively obtaining a nonwoven fabric formed by different fibers of different polymers or polymer mixtures. If polymer melts, polymer solutions or polymer dispersions of the different polymers are spun at once the different fibers are distributed homogenously within the nonwoven fabric. If they are spun consecutively a nonwoven fabric having two or more layers of different fibers are obtained. It is possible to obtain nonwoven fabrics with a layer thickness of less than 15 μm by electrospinning.

The polymer melts; solutions and dispersions used for spinning may contain the further additives (E).

After spinning and deposition the polymers may be crosslinked, e.g. via UV-radiation, ionizing irradiation or radical initiators.

After deposition the nonwoven fabric a posttreatment may be performed to reinforce the nonwoven fabric mechanically or thermally. The posttreatment may be calendaring.

According to one alternative of the present invention (alternative (ii)) the inventive layer system comprises a second fibrous nonwoven fabric (B). The second fibrous nonwoven fabric (B) is aligned parallel to the fibrous nonwoven fabric (A). Preferably the second fibrous nonwoven fabric (B) is selected from the nonwoven fabrics described for the fibrous nonwoven fabric (A). The preferred modifications, selections and embodiments described for the fibrous nonwoven fabric (A) are also the preferred ones of the fibrous nonwoven fabric (B). The second fibrous nonwoven fabric (B) is formed by fibers of one or more organic polymers or mixtures of organic polymers (B1). The polymers and mixtures of organic polymers (B1) are selected from the polymers and polymer mixtures described for the polymers and mixtures of organic polymers (A1) above.

According to another alternative of the present invention (alternative (i)) the fibrous nonwoven fabric (A) contains a polymer electrolyte (C). The polymer electrolyte (C) comprises
(C1) an electrolyte solvent or a mixture of electrolyte solvents, also denoted as electrolyte solvent(s),
(C2) at least one electrolyte salt, also called electrolyte salt(s), and
(C3) at least one organic polymer or polymer mixture.

Alternatives (i) and (ii) may be combined.

According to the present invention the polymer electrolyte (C) comprises at least one organic polymer or polymer mixture (C3) as matrix combined with the electrolyte solvent or a mixture of electrolyte solvents (C1) containing the at least one electrolyte salt (C2).

The organic polymer or polymer mixture (C3) may be soluble or swellable in the electrolyte solvent or mixture of electrolyte solvents (C1) forming a polymer network which is expanded throughout its whole volume by the electrolyte solvent(s) (C1) and the at least one electrolyte salt (C2) solved in the electrolyte solvent(s) (C1). Such kind of polymer electrolyte is usually called a polymer gel electrolyte. The polymer network present in the polymer gel electrolyte may be a chemically crosslinked polymer network or a physically crosslinked polymer network. Physical crosslinking may be caused by crystalline regions in the polymer, ionic interactions, hydrogen bonding or via entanglements of the polymer chains, if the molecular weight of the polymer is above the entanglement molecular weight. The organic polymer or polymer mixture (C3) is soluble or swellable in the in the electrolyte solvent or mixture of electrolyte solvents (C1) according to the present invention, if the degree of swelling in the electrolyte solvent or mixture of electrolyte solvents (C1) is at least 100%, preferably the degree of swelling is in the range of from 100 to 3000%, more preferred 500 to 2000% and most preferred of from 800 to 1000% at 25° C., based on the mass. The method of determining the degree of swelling is described above.

According to the invention it is also possible to use an organic polymer or polymer mixture (C3) as matrix which essentially does not swell or at least only in a moderate extent in the electrolyte solvents(s) but is able to adsorb and retain a sufficient amount the electrolyte solvent(s) (C1) and the electrolyte salt(s) (C2) solved in the electrolyte solvent(s) (C1), for example a porous polymer (C3). The polymer (C3) may be part of the fibrous nonwoven fabric (A) or (B), respectively.

Suited organic polymers (C3) are known to the person skilled in the art. Polymers suited for polymer gel electrolytes may be selected from polyacrylonitril, polymethylmethacrylate, polyvinylpyrrolidone, polyethylene oxide, polypropylene oxide, poly(vinyl chloride), poly(vinylidene fluoride), poly(vinylidene fluoride-co-hexafluoro proplylene).

Polymers suited for adsorbing/retaining the electrolyte solvent(s) (C1) and the electrolyte salt(s) (C2) solved therein are ionomers such as sulfonated fluorine-containing polymers like sulfonated poly(tetrafluoro ethylene), commercially available under the trademark NAFION® by DuPont, polymerised ionic liquids, sulfonated polyether ether ketones, sulfonated polyarylene ether sulfone, sulfonated co-polyimide and sulfonated polystyrene.

The polymer electrolytes used according to the present invention usually have a lithium ion conductivity of at least 10⁻⁷ S/cm, preferably at least 10⁻⁶ S/cm, more preferred at least 10⁻⁵ S/cm, most preferred at least 10⁻⁴ S/cm and in particular at least 10⁻³ S/cm at the working temperature.

A polymer electrolyte (C) in form of a polymer gel electrolyte may be applied to the fibrous nonwoven fabric (A) by providing a solution of the organic polymer or polymer mixture (C3) and of the electrolyte salt(s) (C2) in the electrolyte solvent(s) (C1) and impregnating or coating the fibrous nonwoven fabric (A) with this solution, e.g. with a doctor knife. It is also possible to provide a solution of the organic polymer or polymer mixture (C3) in a solvent, applying the solution on the fibrous nonwoven fabric (A) by methods like spraying, impregnating, coating by a doctor knife etc., to evaporate the solvent and to apply a solution of the electrolyte salt(s) (C2) in the electrolyte solvent(s) (C1), for example by immersing or impregnating the fibrous nonwoven fabric coated with the polymer or polymer mixture (C3) with the solution. A further possibility to apply the polymer gel electrolyte (C) is the application of suited monomers on the fibrous nonwoven fabric (A), e.g. by spraying, coating or immersing the fibrous nonwoven fabric in the monomer(s) or a solution of the monomers optionally containing suited additives like initiators, crosslinking agents etc. and polymerization of the monomers yielding the organic polymer or polymer mixture (C). Afterwards the electrolyte solvent(s) (C1) and electrolyte salt(s) (C2) are applied as described above. The solution of the electrolyte salt(s) (C2) in the electrolyte solvent(s) (C1) may be applied after assembling the electrochemical cell comprising the fibrous nonwoven fabric (A) and optionally (B), too.

A polymer electrolyte (C) adsorbing the solution of electrolyte salt(s) (C2) in the electrolyte solvent(s) (C1) may be provided by incorporating the organic polymer or polymer mixture (C3) into the fibrous nonwoven fabric, i.e. the fibrous nonwoven fabric is formed by fibers of one or more organic polymers or mixtures of organic polymers (A1) and by fibers of at least one organic polymer or polymer mixture (C3). Preferably at least one of the one or more organic polymers or mixtures of organic polymers (A1) used for the manufacture of the fibrous nonwoven fabric (A) is different from the at least one organic polymer or polymer mixture (C3) used. For example a fibrous nonwoven fabric (A) is manufactured having a first layer formed by fibers of an organic polymer or polymer mixture (A1) and a second layer formed by fibers of an organic polymer or polymer mixture (C3) different from the organic polymer or polymer mixture (A1) used in the first layer. It is also possible to provide a fibrous nonwoven fabric having a first layer formed by fibers of an organic polymer or polymer mixture (C3), having a second layer formed by fibers of an organic polymer or polymer mixture (A1) different from the polymer(s) used in the first layer and having a third layer formed by fibers of an organic polymer or polymer mixture (C3) different from the polymer(s) used in the second layer. The polymer(s) (C3) used in the first and the third layer may be same or different. A further possibility is to manufacture the fibrous nonwoven fabric (A) from fibers of an organic polymer or polymer mixture (A1) and from an organic polymer or polymer mixture (C3) wherein the fibers of (A1) and (C3) are homogenously distributed forming one layer of a mixture of the different types of fibers. The solution of the electrolyte salt(s) (C2) in the electrolyte solvent(s) (C1) may be applied directly after preparation of the fibrous nonwoven fabric as described above or after assembling the electrochemical cell the fibrous nonwoven fabric (A) and possibly fibrous nonwoven fabric (B).

The fibrous nonwoven fabric (B) may contain a polymer electrolyte (D) comprising
(D1) an electrolyte solvent or a mixture of electrolyte solvents, also denoted as electrolyte solvent(s) (D1)
(D2) at least one electrolyte salt, also called electrolyte salt(s) (D2) and
(D3) at least one organic polymer or polymer mixture.

The polymer electrolyte (D) is selected from the polymer electrolytes (C) as described herein.

The electrolyte solvent or a mixture of electrolyte solvents (C1) and (D1) are selected from the electrolyte solvents known by the person skilled in the art. Preferably the electrolyte solvent(s) (C1) and (D1) are aprotic solvents, more preferred from organic aprotic solvents. The organic aprotic solvents may be partially fluorinated. Suitable organic aprotic solvents are
(a) cyclic and noncyclic organic carbonates,
(b) di-C₁-C₁₀-alkylethers
(c) di-C₁-C₄-alkyl-C₂-C₆-alkylene ethers and polyethers,
(d) cyclic ethers,
(e) cyclic and acyclic acetales and ketales,
(f) orthocarboxylic acids esters and
(g) cyclic and noncyclic esters of carboxylic acids.

More preferred the at least one aprotic organic solvent (A) is selected from di-C₁-C₁₀-alkylethers (b), cyclic ethers (d) and cyclic und acyclic acetales and ketales (e), even more preferred the composition contains at least two aprotic organic solvent (A) selected from di-C₁-C₁₀-alkylethers (b), cyclic ethers (d) and cyclic und acyclic acetales and ketales (e).

Among the aforesaid aprotic organic solvents (A) such solvents and mixtures of solvents (A) are preferred which are liquid at 1 bar and 25° C.

Examples of suitable organic carbonates (a) are cyclic organic carbonates according to the general formula (Ia), (Ib) or (Ic)

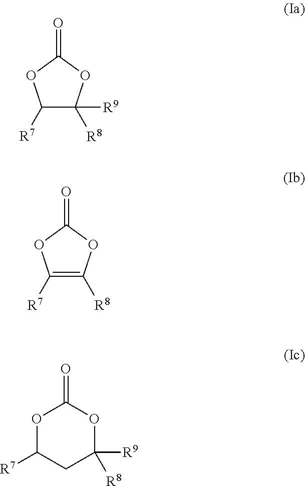

wherein

R¹, R⁸ und R⁹ being different or equal and being independently from each other selected from hydrogen and C₁-C₄-alkyl, preferably methyl; F, and C₁-C₄-alkyl substituted by one or more F, e.g. CF₃.

“C₁-C₄-alkyl” is intended to include methyl, ethyl, n-propyl, iso-propyl, n-butyl, iso-butyl, sec.-butyl and tert.-butyl.

Preferred cyclic organic carbonates (a) are of general formula (Ia), (Ib) or (Ic) wherein R⁸ and R⁹ are H. A further preferred cyclic organic carbonate (a) is difluorethylencarbonate

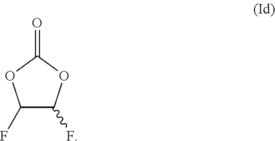

Examples of suitable non-cyclic organic carbonates (a) are dimethyl carbonate, diethyl carbonate, methylethyl carbonate and mixtures thereof.

In one embodiment of the invention the electrolyte composition contains mixtures of non-cyclic oganic carbonates (a) and cyclic organic carbonates (a) at a ratio by weight of from 1:10 to 10:1, preferred of from 3:1 to 1:1.

Examples of suitable non-cyclic di-C₁-C₁₀-alkylethers (b) are dimethylether, ethylmethylether, diethylether, diisopropylether, and di-n-butylether.

Examples of di-C₁-C₄-alkyl-C₂-C₆-alkylene ethers (c) are 1,2-dimethoxyethane, 1,2-diethoxyethane, diglyme(diethylene glycol dimethyl ether), triglyme(triethylenglycol dimethyl ether), tetraglyme(tetraethylenglycol dimethyl ether), and diethylenglycoldiethylether. Examples of suitable polyethers (c) are especially polyalkylene glycols, preferably poly-C₁-C₄-alkylene glycols and especially polyethylene glycols. Polyethylene glycols may comprise up to 20 mol % of one or more C₁-C₄-alkylene glycols in copolymerized form. Polyalkylene glycols are preferably dimethyl- or diethyl-end capped polyalkylene glycols. The molecular weight M_{w} of suitable polyalkylene glycols and especially of suitable polyethylene glycols may be at least 400 g/mol. The molecular weight M_{w} of suitable polyalkylene glycols and especially of suitable polyethylene glycols may be up to 5 000 000 g/mol, preferably up to 2 000 000 g/mol.

Examples of suitable cyclic ethers (d) are tetrahydrofurane and 1,4-dioxane.

Examples of suitable non-cyclic acetals (e) are 1,1-dimethoxymethane and 1,1-diethoxymethane. Examples for suitable cyclic acetals (e) are 1,3-dioxane and 1,3-dioxolane.

Examples of suitable orthocarboxylic acids esters (f) are tri-C₁-C₄ alkoxy methane, in particular trimethoxymethane and triethoxymethane.

Examples for suitable noncyclic esters of carboxylic acids (g) are ethyl acetate, methyl butanoate, esters of dicarboxylic acids like 1,3-dimethyl propanedioate. An example of a suitable cyclic ester of carboxylic acids (lactones) is γ-butyrolactone.

A preferred mixtures of solvents (A) contains at least one di-C₁-C₁₀-alkylether (b) and at least one cyclic and acyclic acetales and ketales (e), in particular the mixtures of solvents (A) contains dimethylether (DME) and1,3-dioxolane (DOL).

The electrolyte salt(s) (C2) and (D2) are preferably selected from lithium salts. The lithium salts are preferably monovalent salts, i.e. salts with monovalent anions. The lithium salt(s) (C2 and (D2) may be selected from the group consisting of LiPF₆, LiPF₃(CF₂CF₃)₃, LiClO₄, LiAsF₆, LiCF₃SO₃, LiN(SO₂F)₂, Li₂SiF₆, LiSbF₆, LiAlCl₄, lithium (bisoxalato) borate (LiBOB), lithium difluoro (oxalato) borate (LiDFOB), and lithium tetrafluoro borate, and salts of the general formula (CₙF₂ₙ₊₁SO₂)ₘXLi, where m and n are defined as follows:

m=1 when X is selected from oxygen and sulfur,

m=2 when X is selected from nitrogen and phosphorus,

m=3 when X is selected from carbon and silicon, and

n is an integer in the range from 1 to 20,

like LiC(CₙF₂ₙ₊₁SO₂)₃ wherein n is an integer in the range from 1 to 20, and lithium imides such as LiN(CₙF₂ₙ₊₁SO₂)₂, where n is an integer in the range from 1 to 20.

Preferably the lithium salt(s) (C2) and (D2) are selected from LiPF₆, LiSbF₆, LiBOB, (LiDFOB), lithium tetrafluoro borate, LiCF₃SO₃, LiPF₃(CF₂CF₃)₃, LiN(SO₂F)₂ and LiN(CF₃SO₂)₂. The most preferred lithium salt (D) is LiN(CF₃SO₂)₂ If a fibrous nonwoven fabric (B) containing a polymer electrolyte (D) is present in the inventive layer system, it is preferred that the lithium salt(s) (C2) and (D2) are the same.

According to one embodiment the inventive layer system comprises at least one fibrous nonwoven fabric (A) formed by fibers of one or more organic polymers or mixtures of organic polymers (A1) wherein the fibrous nonwoven fabric (A) contains a polymer electrolyte (C) comprising
(C1) an electrolyte solvent or a mixture of electrolyte solvents,
(C2) at least one electrolyte salt, and
(C3) at least one organic polymer or polymer mixture.

According to another embodiment the inventive layer system comprises at least one fibrous nonwoven fabric (A) formed by fibers of one or more organic polymers or mixtures of organic polymers (A1) and a second fibrous nonwoven fabric (B) formed by fibers of one or more organic polymers or mixtures of organic polymers (B1) wherein (B) is aligned parallel to (A).

According to a further embodiment the inventive layer system comprises at least one fibrous nonwoven fabric (A) formed by fibers of one or more organic polymers or mixtures of organic polymers (A1) wherein the fibrous nonwoven fabric (A) contains a polymer electrolyte (C) comprising
(C1) an electrolyte solvent or a mixture of electrolyte solvents,
(C2) at least one electrolyte salt, and
(C3) at least one organic polymer or polymer mixture,

and a second fibrous nonwoven fabric (B) formed by fibers of one or more organic polymers or mixtures of organic polymers (B1) wherein (B) is aligned parallel to (A).

According to another embodiment the inventive layer system comprises at least one fibrous nonwoven fabric (A) formed by fibers of one or more organic polymers or mixtures of organic polymers (A1) and a second fibrous nonwoven fabric (B) formed by fibers of one or more organic polymers or mixtures of organic polymers (B1) wherein (B) is aligned parallel to (A) and wherein (B) contains a polymer electrolyte (D) comprising
(D1) an electrolyte solvent or a mixture of electrolyte solvents,
(D2) at least one electrolyte salt, and
(D3) at least one organic polymer or polymer mixture.

According to a further embodiment the inventive layer system comprises at least one fibrous nonwoven fabric (A) formed by fibers of one or more organic polymers or mixtures of organic polymers (A1) wherein the fibrous nonwoven fabric (A) contains a polymer electrolyte (C) comprising
(C1) an electrolyte solvent or a mixture of electrolyte solvents,
(C2) at least one electrolyte salt, and
(C3) at least one organic polymer or polymer mixture,

and a second fibrous nonwoven fabric (B) formed by fibers of one or more organic polymers or mixtures of organic polymers (B1) wherein (B) is aligned parallel to (A) and wherein (B) contains a polymer electrolyte (D) comprising
(D1) an electrolyte solvent or a mixture of electrolyte solvents,
(D2) at least one electrolyte salt, and
(D3) at least one organic polymer or polymer mixture.

The term “(B) is aligned parallel to (A)” means that the fibrous nonwoven fabric (A) and fibrous nonwoven fabric (B) are stacked like a laminate.

The fibrous nonwoven fabrics (A) and (B) usually have a total thickness of at maximum 100 μm, preferred at maximum 50 μm, more preferred of from 2 to 30 μm and most preferred of from 5 to 20 μm, measured in the dry state.

An example for a suitable combination of materials for use in the present invention comprises polyvinylpyrrolidone as polymer (A1) forming the fibrous nonwoven fabric (A). The fibrous nonwoven fabric (A) is manufactured by electrospinning. A polymer electrolyte (C) is prepared by adding polyethyleneoxide to a solution of LiN(CF₃SO₂)₂ in a mixture of 1,3-dioxolane and dimethylether. Consequently the nonwoven fabric (A) may be impregnated with the polymerelectrolyte (C).

The inventive layer system may be used as protective layer for an electrode of an electrochemical cell. Therefore, a further object of the present invention is an electrode comprising the layer system as described above. The electrode may be a cathode or an anode. The cathode may be the cathode of a lithium ion battery comprising a lithium ion intercalating compound as cathode active material like transition metal oxides or lithium iron phosphates, or the cathode of a lithium sulphur battery comprising sulphur as cathode active material, e.g. elemental sulphur. The anode may be the anode of a lithium ion battery comprising for instance lithium ion intercalating carbon as anode active material, preferably the anode contains graphite, and in particular the anode consists essentially of graphite, or the anode of a lithium sulphur battery comprising elemental lithium or a lithium alloy as anode active material.

Further object of the present invention is an electrochemical cell comprising the inventive layer system as described above. The inventive layer system may be used as protective layer for the anode and/or cathode, as electrolyte and/or as separator. The electrochemical cell is preferably a lithium battery, in particular lithium ion battery or lithium sulphur battery. The electrochemical cell comprises an anode, a cathode, and at least one inventive layer system and optionally an additional electrolyte system comprising at least one electrolyte solvent selected from the electrolyte solvent(s) (C1) and at least one electrolyte salt selected form the electrolyte salt(s) (C2) described above.

The electrochemical cell comprising the inventive the layer system may comprise more than one electrolyte, for example two different electrolytes. One electrolyte may be part of the layer system and the other one may be an additional electrolyte. It is also possible, that the inventive layer system itself comprises two different electrolytes, e.g. the layer system comprises a fibrous nonwoven fabric (A) impregnated with a first polymer gel electrolyte and a fibrous nonwoven fabric (B) impregnated with a second polymer gel electrolyte different from the first polymer gel electrolyte. According to one embodiment the electrochemical cell comprises two different electrolytes.

The inventive electrochemical cells may contain further constituents customary per se, for example output conductors, separators, housings, cable connections etc. Output conductors may be configured in the form of a metal wire, metal grid, metal mesh, expanded, metal, metal sheet or metal foil. Suitable metal foils are especially aluminum foils. The housing may be of any shape, for example cuboidal or in the shape of a cylinder. In another embodiment, inventive electrochemical cells have the shape of a prism. In one variant, the housing used is a metal-plastic composite film processed as a pouch.

Several inventive electrochemical cells may be combined with one another, for example in series connection or in parallel connection. Series connection is preferred. The present invention further provides for the use of inventive electrochemical cells as described above in automobiles, bicycles operated by electric motor, aircraft, ships or stationary energy stores.

The present invention therefore also further provides for the use of inventive electrochemical cells in devices, especially in mobile devices. Examples of mobile devices are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

Furthermore, the present invention provide a process for producing an inventive electrode as described above comprising the steps
(a) providing at least one spinning mixture containing at least one solvent and at least one organic polymer or polymer mixture (A1),
(b) arranging the electrode as counter electrode in an elecrospinning device,
(c) electrospinning the spinning mixture or spinning mixtures obtaining a nonwoven fibrous fabric (A) deposited on the electrode,
(d) optionally crosslinking the organic polymer or polymer mixture (A1), and
(e) providing a polymer electrolyte (C) comprising
   (C1) one electrolyte solvent or a mixture of electrolyte solvents,
   (C2) at least one electrolyte salt, and
   (C3) at least one organic polymer or polymer mixture
   and impregnating the nonwoven fibrous fabric (A) with the polymer electrolyte (C) or impregnating the nonwoven fibrous fabric (A) with an electrolyte containing
   (C1) one electrolyte solvent or a mixture of electrolyte solvents, and
   (C2) at least one electrolyte salt,
   and/or
(f) arranging a second fibrous nonwoven fabric (B) formed by fibers of one or more organic polymers or mixtures of organic polymers (B1) on the nonwoven fibrous fabric (A) and optionally providing a polymer electrolyte (D) and impregnating the nonwoven fibrous fabric (B) with the polymer electrolyte (D).

1. A layer system for electrochemical cells, comprising:
(i) a fibrous nonwoven fabric A obtained by fibers of one or more organic polymers or mixtures of organic polymers A1, wherein
the fibrous nonwoven fabric A comprises a polymer electrolyte C comprising:
(C1) an electrolyte solvent or a mixture of electrolyte solvents,
(C2) an electrolyte salt, and
(C3) an organic polymer or a polymer mixture;
(ii) a second fibrous nonwoven fabric B obtained by fibers of one or more organic polymers or mixtures of organic polymers B1 and aligned parallel to A, wherein B optionally comprises a polymer electrolyte D comprising:
(D1) an electrolyte solvent or a mixture of electrolyte solvents,
(D2) an electrolyte salt, and
(D3) an organic polymer or a polymer mixture; or both (i) and (ii).

2. The layer system according to claim 1, wherein a thickness of the fibrous nonwoven fabrics A and B is at maximum 100 μm, measured in a dry state.

3. The layer system according to claim 1, wherein the fibrous nonwoven fabric A has a porosity of at least 30%, determined according to ASTM D-2873.

4. The layer system according to claim 1, wherein the fibers of the fibrous nonwoven fabric A have a diameter diameters of from 50 to 3000 nm.

5. The layer system according to claim 1, wherein the organic polymers or mixtures of organic polymers A1 are selected from the group consisting of a homo- and copolymer of an aromatic vinylic monomer, a homo- and copolymer of an alkyl(meth)acrylate, a homo- and copolymer of an α-olefine, a homo- and copolymer of an aliphatic diene, a homo- and copolymer of a vinyl halide, a homo- and copolymer of vinyl acetate and a hydrolyzate, a homo- and copolymer of acrylonitrile, a homo- and copolymer of a sulfone, a homo- and copolymer of benzimidazole, a homo- and copolymer of a siloxane, an amino formaldehyde resin, a homo- and copolyamide, a homo- and copolyurethane, a homo- and copolyester, a homo- and copolyether, a homo- and copolyvinylpyrrolidone, a homo- and copolyvinylimidazol, a polymeric ionic liquid, an ionomer, a copolymer obtained by two or more of the aforesaid monomers and monomer units, and any mixture thereof.

6. The layer system according to claim 1, wherein the organic polymers or mixtures of organic polymers A1 are selected from the group consisting of polvinylalcohol, polyvinylidene fluoride, polytetrafluoro ethylene, polyethylene terephthalate, polybutylene terephthalate, polysulfone, polyphenylene sulfone, melamine formaldehyde resin, polyacrylonitrile, polybenzimidazole, polypropyleneoxide, polytetrahydrofurane, sulfonated poly(tetrafluoro ethylene), sulfonated polyether ether ketones, sulfonated polyarylene ether sulfone, sulfonated co-polyimide, sulfonated polystyrene, polyethylene oxide, and any mixture thereof.

7. The layer system according to claim 1, wherein the organic polymer or mixtures of organic polymers A1 are cross-linked.

8. The layer system according to claim 1, wherein the fibrous nonwoven fabric A comprises an additive E.

9. The layer system according to claim 1, wherein the fibrous nonwoven fabric A is obtained by two layers of fibers obtained by different organic polymers or mixtures of organic polymers A1.

10. The layer system according to claim 1, wherein the fibrous nonwoven fabric A is spunbond.

11. An electrode comprising the layer system according to claim 1.

12. An electrochemical cell comprising the layer system according to claim 1.

13. The electrochemical cell according to claim 12, wherein the electrochemical cell is a lithium battery.

14. The electrochemical cell according to claim 12, wherein the electrochemical cell comprises two different electrolytes.

15. A process for producing the electrode according to claim 11, comprising:
(a) obtaining at least one spinning mixture comprising a solvent and an organic polymer or a polymer mixture A1;
(b) arranging the electrode as counter electrode in an elecrospinning device;
(c) electrospinning the at least one spinning mixture, thereby obtaining the fibrous nonwoven fabric A deposited on the electrode;
(d) optionally crosslinking the organic polymer or polymer mixture A1;
(e) obtaining the polymer electrolyte C
and impregnating the fibrous nonwoven fabric A with the polymer electrolyte C or impregnating the fibrous nonwoven fabric A with an electrolyte comprising
(C1) an electrolyte solvent or a mixture of electrolyte solvents, and
(C2) an electrolyte salt;
and
(f) optionally arranging the second fibrous nonwoven fabric B obtained by fibers of the one or more organic polymers or mixtures of organic polymers B1 on the fibrous nonwoven fabric A, and optionally obtaining the polymer electrolyte D and impregnating the fibrous nonwoven fabric B with the polymer electrolyte D.
